(19) United States
(12) Patent Application Publication
(10) Pub. No.: US 2026/0301414 A1
(43) Pub. Date: Oct. 1, 2026

(54) GENERATING AN OPEN-VOCABULARY BIRD'S EYE VIEW FOR A VEHICLE

(71) Applicant: GM Global Technology Operations LLC, Detroit, MI (US)

(72) Inventors: Guy Heller, Tel Aviv (IL); Hila Levi, Rechovot (IL)

(21) Appl. No.: 19/091,123

(22) Filed: Mar. 26, 2025

(51) Int. Cl. G06V 20/56; B60W 60/00; G06T 9/00; G06V 10/44

(52) U.S. Cl. CPC G06V 20/56; B60W 60/001; G06T 9/00; G06V 10/44; G06V 2201/07

(57) ABSTRACT

A system for adjusting an operation of a vehicle may include a controller programmed to capture the plurality of images of the environment surrounding the vehicle using a camera system. The controller is further programmed to encode one or more features in one or more of the plurality of images using an open-vocabulary vision-language model. One of the one or more features is encoded as an image feature vector. The image feature vector is aligned near a corresponding textual feature vector in a feature space. The corresponding textual feature vector is generated based on a textual description of the one of the one or more features. The controller is further programmed to generate an open-vocabulary two-dimensional bird's eye view (BEV) representation of the environment surrounding the vehicle based at least in part on the one or more features.

### INTRODUCTION

The present disclosure relates to systems and methods for environmental sensing and mapping for vehicles.

To enable real-time perception and navigation, environmental sensing and mapping systems may be utilized. These systems may utilize software algorithms that process sensor data from sources such as cameras, LiDAR, radar, and/or ultrasonic sensors to construct a digital representation of the vehicle’s surroundings. Sensor fusion techniques may be used to integrate multiple data streams, improving accuracy and robustness by compensating for individual sensor limitations. Mapping software may employ simultaneous localization and mapping (SLAM) techniques, enabling the vehicle to generate and update high-fidelity maps while tracking its position. In some examples, environmental sensing software utilizes machine learning models to identify or classify objects and/or road features. Other vehicle systems, such as, for example advanced driver assistance systems (ADAS) and/or automated driving systems (ADS) may provide information to occupants and/or adjust automated vehicle routing based on detected and/or identified objects/features.

While current systems and methods for environmental sensing and mapping for vehicles achieve their intended purpose, there is a need for a new and improved system and method for vehicles to identify, classify, and/or contextualize objects in the environment.

### SUMMARY

According to several aspects, a system for adjusting an operation of a vehicle is provided. The system may include a camera system configured to capture a plurality of images of an environment surrounding the vehicle. The system further may include a controller in electrical communication with the camera system. The controller is programmed to capture the plurality of images of the environment surrounding the vehicle using the camera system. The controller is further programmed to encode one or more features in one or more of the plurality of images using an image encoder. One of the one or more features is encoded as an image feature vector. The image feature vector is aligned near a corresponding textual feature vector in a feature space. The corresponding textual feature vector is generated based on a textual description of the one of the one or more features. The controller is further programmed to generate a two-dimensional bird's eye view (BEV) representation of the environment surrounding the vehicle based at least in part on the one or more features. The controller is further programmed to adjust the operation of the vehicle based at least in part on information about the environment surrounding the vehicle encoded in the BEV representation.

In another aspect of the present disclosure, the plurality of images includes at least one image showing an environment in front of the vehicle, at least one image showing an environment behind the vehicle, at least one image showing an environment left of the vehicle, and at least one image showing an environment right of the vehicle.

In another aspect of the present disclosure, to generate the BEV, the controller is further programmed to identify one or more image feature vectors corresponding to each of a plurality of two-dimensional locations in the environment surrounding the vehicle. To generate the BEV, the controller is further programmed to generate a plurality of BEV image feature vectors. Each of the plurality of BEV image feature vectors corresponds to one of the plurality of two-dimensional locations. Each of the plurality of BEV image feature vectors is an average of the one or more image feature vectors corresponding to the one of the plurality of two-dimensional locations.

In another aspect of the present disclosure, each of the plurality of BEV image feature vectors is an average of the one or more image feature vectors located two or more heights at the one of the plurality of two-dimensional locations.

In another aspect of the present disclosure, the image encoder is part of an open-vocabulary vision-language model configured for open-vocabulary, zero-shot classification by generating image feature vectors aligned near corresponding textual feature vectors in the feature space.

In another aspect of the present disclosure, the open-vocabulary vision-language model is a Contrastive Language-Image Pretraining (CLIP) image encoder.

In another aspect of the present disclosure, to adjust the operation of the vehicle, the controller is further programmed to search the BEV representation with a textual query. To adjust the operation of the vehicle, the controller is further programmed to save the plurality of images in a non-transitory memory in response to identifying the textual query in the BEV representation.

In another aspect of the present disclosure, to adjust the operation of the vehicle, the controller is further programmed to search the BEV representation with a textual query. To adjust the operation of the vehicle, the controller is further programmed to identify one or more objects in the environment surrounding the vehicle based at least in part on the textual query using the BEV representation. To adjust the operation of the vehicle, the controller is further programmed to adjust an automated routing of the vehicle based at least in part on the one or more objects in the environment.

In another aspect of the present disclosure, the system further may include an automated driving system in electrical communication with the controller. To adjust the automated routing of the vehicle, the controller is further programmed to calculate an automated route for the vehicle based at least in part on the one or more objects in the environment using the automated driving system. To adjust the automated routing of the vehicle, the controller is further programmed to control an acceleration, braking, and/or steering of the vehicle using the automated driving system to route the vehicle along the automated route.

In another aspect of the present disclosure, the system further may include a vehicle communication system in electrical communication with the controller. The controller is further programmed to transmit the plurality of images and the BEV representation to a remote server system using the vehicle communication system. The remote server system is configured to store the plurality of images and the BEV representation and allow for querying and retrieval of images using textual queries.

According to several aspects, a method for adjusting an operation of a vehicle is provided. The method may include capturing a plurality of images of an environment surrounding the vehicle using a camera system. The method further may include encoding one or more features in one or more of the plurality of images using an image encoder. Encoding the one or more features further includes generating one or more image feature vectors using the image encoder. Each of the one or more image feature vectors corresponds to one of the one or more features. Each of the one or more image feature vectors is aligned near a corresponding textual feature vector in a feature space. The method further may include generating a two-dimensional bird's eye view (BEV) representation of the environment surrounding the vehicle based at least in part on the one or more features. The method further may include adjusting the operation of the vehicle based at least in part on information about the environment surrounding the vehicle encoded in the BEV representation.

In another aspect of the present disclosure, capturing the plurality of images further includes capturing at least one image showing an environment in front of the vehicle, at least one image showing an environment behind the vehicle, at least one image showing an environment left of the vehicle, and at least one image showing an environment right of the vehicle.

In another aspect of the present disclosure, identifying one or more features further may include generating the one or more image feature vectors using the image encoder. The image encoder is part of an open-vocabulary vision-language model.

In another aspect of the present disclosure, generating the BEV further may include identifying one or more image feature vectors corresponding to each of a plurality of two-dimensional locations in the environment surrounding the vehicle. Generating the BEV further may include generating a plurality of BEV image feature vectors. Each of the plurality of BEV image feature vectors corresponds to one of the plurality of two-dimensional locations. Each of the plurality of BEV image feature vectors is an average of the one or more image feature vectors corresponding to the one of the plurality of two-dimensional locations.

In another aspect of the present disclosure, generating the BEV further may include generating the plurality of BEV image feature vectors. Each of the plurality of BEV image feature vectors corresponds to one of the plurality of two-dimensional locations. Each of the plurality of BEV image feature vectors is an average of the one or more image feature vectors corresponding to two or more heights at the one of the plurality of two-dimensional locations.

In another aspect of the present disclosure, adjusting the operation of the vehicle further may include searching the BEV representation with a textual query. Adjusting the operation of the vehicle further may include identifying one or more objects in the environment surrounding the vehicle based at least in part on the textual query using the BEV representation. Adjusting the operation of the vehicle further may include adjusting an automated routing of the vehicle based at least in part on the one or more objects in the environment.

In another aspect of the present disclosure, adjusting the automated routing of the vehicle further may include calculating an automated route for the vehicle based at least in part on the one or more objects in the environment using an automated driving system. Adjusting the automated routing of the vehicle further may include controlling an acceleration, braking, and/or steering of the vehicle using the automated driving system to route the vehicle along the automated route.

According to several aspects, a system for adjusting an operation of a vehicle is provided. The system may include a camera system configured to capture a plurality of images of an environment surrounding the vehicle and a controller in electrical communication with the camera system. The controller is programmed to capture the plurality of images of the environment surrounding the vehicle using the camera system. The plurality of images includes at least one image showing an environment in front of the vehicle, at least one image showing an environment behind the vehicle, at least one image showing an environment left of the vehicle, and at least one image showing an environment right of the vehicle. The controller is programmed to encode one or more features in one or more of the plurality of images using an image encoder. One of the one or more features is encoded as an image feature vector. The image feature vector is aligned near a corresponding textual feature vector in a feature space. The corresponding textual feature vector is generated based on a textual description of the one of the one or more features. The controller is programmed to generate a two-dimensional bird's eye view (BEV) representation of the environment surrounding the vehicle based at least in part on the one or more features. The controller is programmed to adjust an automated routing of the vehicle based at least in part on information about the environment surrounding the vehicle encoded in the BEV representation.

In another aspect of the present disclosure, to generate the BEV, the controller is further programmed to identify one or more image feature vectors corresponding to each of a plurality of two-dimensional locations in the environment surrounding the vehicle. To generate the BEV, the controller is further programmed to generate a plurality of BEV image feature vectors. Each of the plurality of BEV image feature vectors corresponds to one of the plurality of two-dimensional locations. Each of the plurality of BEV image feature vectors is an average of the one or more image feature vectors corresponding to the one of the plurality of two-dimensional locations.

In another aspect of the present disclosure, the system further may include an automated driving system in electrical communication with the controller. To adjust the automated routing of the vehicle, the controller is further programmed to search the BEV representation with a textual query. To adjust the automated routing of the vehicle, the controller is further programmed to identify one or more objects in the environment surrounding the vehicle based at least in part on the textual query using the BEV representation. To adjust the automated routing of the vehicle, the controller is further programmed to calculate an automated route for the vehicle based at least in part on the one or more objects in the environment using the automated driving system. To adjust the automated routing of the vehicle, the controller is further programmed to control an acceleration, braking, and/or steering of the vehicle using the automated driving system to route the vehicle along the automated route.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for adjusting an operation of a vehicle, according to an exemplary embodiment;

FIG. 2 is a flowchart of a method for adjusting an operation of a vehicle, according to an exemplary embodiment; and

FIG. 3 is a block diagram illustrating the method of FIG. 2, according to an exemplary embodiment.

### DETAILED DESCRIPTION

The following description is merely exemplary in nature and is not intended to limit the present disclosure, application, or uses.

In aspects of the present disclosure, it is advantageous to detect and identify and/or classify objects in the environment surrounding a vehicle. For example, in the context of autonomous vehicles, path planning algorithms may use data about objects in the environment to generate a path for the vehicle to follow. Accordingly, the present disclosure provides a new and improved system and method for adjusting an operation of a vehicle which allows for identification/classification of objects and road elements which were not present or annotated in training data while also providing increased semantic information/context about identified objects in an open-vocabulary manner.

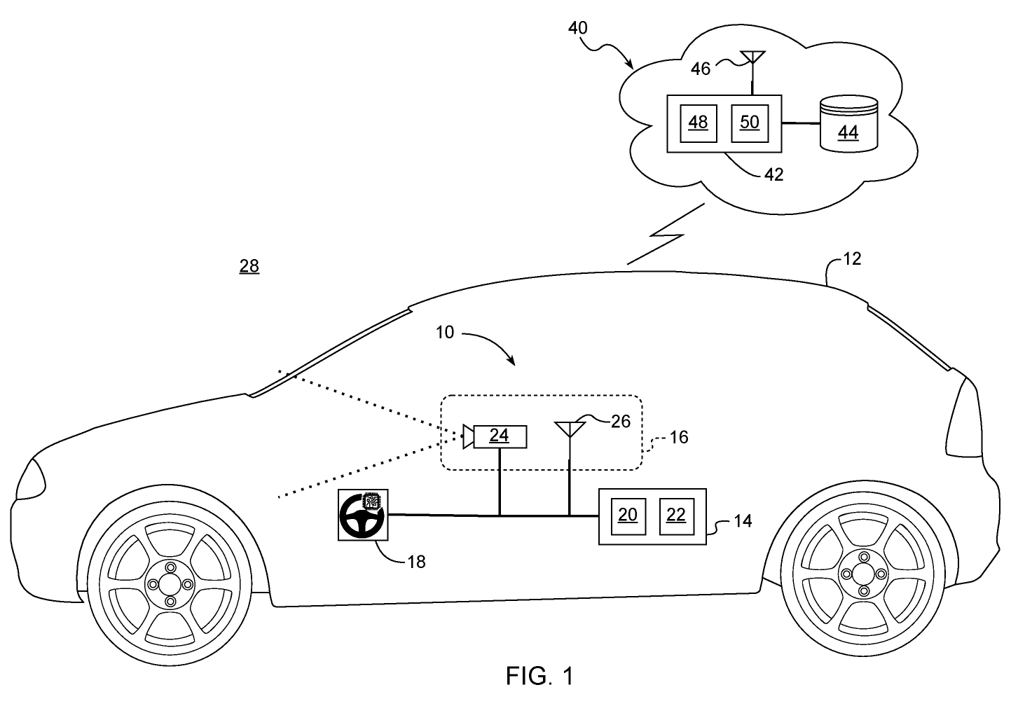

Referring to FIG. 1, a system for adjusting an operation of a vehicle is illustrated and generally indicated by reference number 10. The system 10 is shown with an exemplary vehicle 12. While a passenger vehicle is illustrated, it should be appreciated that the vehicle 12 may be any type of vehicle without departing from the scope of the present disclosure. The system 10 generally includes a controller 14, one or more vehicle sensors 16, and an automated driving system 18.

The controller 14 is used to implement a method 100 for adjusting an operation of a vehicle, as will be described below. The controller 14 includes at least one processor 20 and a non-transitory computer readable storage device or media 22. The processor 20 may be a custom made or commercially available processor, a central processing unit (CPU), a graphics processing unit (GPU), an auxiliary processor among several processors associated with the controller 14, a semiconductor-based microprocessor (in the form of a microchip or chip set), a macroprocessor, a combination thereof, or generally a device for executing instructions.

The computer readable storage device or media 22 may include volatile and nonvolatile storage in read-only memory (ROM), random-access memory (RAM), and keep-alive memory (KAM), for example. KAM is a persistent or non-volatile memory that may be used to store various operating variables while the processor 20 is powered down. The computer-readable storage device or media 22 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 14 to control various systems of the vehicle 12.

The controller 14 may also include multiple controllers which are in electrical communication with each other. The controller 14 may be inter-connected with additional systems and/or controllers of the vehicle 12, allowing the controller 14 to access data such as, for example, speed, acceleration, braking, and steering angle of the vehicle 12.

The controller 14 is in electrical communication with the one or more vehicle sensors 16 and the automated driving system 18. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the controller 14 are within the scope of the present disclosure. It should further be understood that, in the scope of the present disclosure, electrical communication also includes power and/or energy transfer between electrical devices (e.g., using conducting wires and/or wireless power transmission techniques).

The one or more vehicle sensors 16 are used to acquire information relevant to the vehicle 12. In an exemplary embodiment, the one or more vehicle sensors 16 includes at least a camera system 24 and a vehicle communication system 26.

In another exemplary embodiment, the one or more vehicle sensors 16 further includes sensors to determine performance data about the vehicle 12. In a non-limiting example, the one or more vehicle sensors 16 further includes at least one of a motor speed sensor, a motor torque sensor, an electric drive motor voltage and/or current sensor, an accelerator pedal position sensor, a brake position sensor, a coolant temperature sensor, a cooling fan speed sensor, and a transmission oil temperature sensor.

In another exemplary embodiment, the one or more vehicle sensors 16 further includes sensors to determine information about an environment within the vehicle 12. In a non-limiting example, the one or more vehicle sensors 16 further includes at least one of a seat occupancy sensor, a cabin air temperature sensor, a cabin motion detection sensor, a cabin camera, a cabin microphone, and/or the like.

In another exemplary embodiment, the one or more vehicle sensors 16 further includes sensors to determine information about an environment 28 surrounding the vehicle 12. In a non-limiting example, the one or more vehicle sensors 16 further includes at least one of an ambient air temperature sensor, a barometric pressure sensor, a global navigation satellite system (GNSS), and/or a photo and/or video camera which is positioned to view the environment 28 in front of the vehicle 12.

In another exemplary embodiment, at least one of the one or more vehicle sensors 16 is a perception sensor capable of perceiving objects and/or measuring distances in the environment 28 surrounding the vehicle 12. In a non-limiting example, the one or more vehicle sensors 16 includes a stereoscopic camera having distance measurement capabilities. In one example, at least one of the one or more vehicle sensors 16 is affixed inside of the vehicle 12, for example, in a headliner of the vehicle 12, having a view through a windscreen of the vehicle 12. In another example, at least one of the one or more vehicle sensors 16 is affixed outside of the vehicle 12, for example, on a roof of the vehicle 12, having a view of the environment 28 surrounding the vehicle 12. It should be understood that various additional types of perception sensors, such as, for example, LiDAR sensors, ultrasonic ranging sensors, radar sensors, and/or time-of-flight sensors are within the scope of the present disclosure. The one or more vehicle sensors 16 are in electrical communication with the controller 14 as discussed above.

The camera system 24 is a perception sensor used to capture images and/or videos of the environment 28 surrounding the vehicle 12. In an exemplary embodiment, the camera system 24 includes a photo and/or video camera which is positioned to view the environment 28 surrounding the vehicle 12. In a non-limiting example, the camera system 24 includes a camera affixed inside of the vehicle 12, for example, in a headliner of the vehicle 12, having a view through the windscreen. In another non-limiting example, the camera system 24 includes a camera affixed outside of the vehicle 12, for example, on a roof of the vehicle 12, having a view of the environment 28 in front of the vehicle 12.

In another exemplary embodiment, the camera system 24 is a surround view camera system including a plurality of cameras arranged to provide a view of the environment 28 adjacent to all sides of the vehicle 12. In a non-limiting example, the camera system 24 includes a front-facing camera (mounted, for example, in a front grille of the vehicle 12), a rear-facing camera (mounted, for example, on a rear tailgate of the vehicle 12), and two side-facing cameras (mounted, for example, under each of two side-view mirrors of the vehicle 12). In another non-limiting example, the camera system 24 further includes an additional rear-view camera mounted near a center high mounted stop lamp of the vehicle 12. Accordingly, the camera system 24 is configured to capture images showing an environment in front of the vehicle 12, images showing an environment behind the vehicle 12, images showing an environment left of the vehicle 12, and images showing an environment right of the vehicle 12. In a non-limiting example, the two side-facing cameras include both front and rear facing side cameras, allowing the camera system 24 to capture a front- and rear-ward view on each side of the vehicle 12. It should be understood that the system 10 and method 100 of the present disclosure may also be used with fewer cameras (e.g., one camera), but more cameras will provide a more complete view of the environment 28.

It should be understood that camera systems having additional cameras and/or additional mounting locations are within the scope of the present disclosure. It should further be understood that cameras having various sensor types including, for example, charge-coupled device (CCD) sensors, complementary metal oxide semiconductor (CMOS) sensors, and/or high dynamic range (HDR) sensors are within the scope of the present disclosure. Furthermore, cameras having various lens types including, for example, wide-angle lenses and/or narrow-angle lenses are also within the scope of the present disclosure.

The vehicle communication system 26 is used by the controller 14 to communicate with other systems external to the vehicle 12. For example, the vehicle communication system 26 includes capabilities for communication with vehicles (“V2V” communication), infrastructure (“V2I” communication), remote systems at a remote call center (e.g., ON-STAR by GENERAL MOTORS) and/or personal devices. In general, the term vehicle-to-everything communication (“V2X” communication) refers to communication between the vehicle 12 and any remote system (e.g., vehicles, infrastructure, and/or remote systems).

In certain embodiments, the vehicle communication system 26 is a wireless communication system configured to communicate via a wireless local area network (WLAN) using IEEE 802.11 standards or by using cellular data communication (e.g., using GSMA standards, such as, for example, SGP.02, SGP.22, SGP.32, and the like). Accordingly, the vehicle communication system 26 may further include an embedded universal integrated circuit card (eUICC) configured to store at least one cellular connectivity configuration profile, for example, an embedded subscriber identity module (eSIM) profile.

The vehicle communication system 26 is further configured to communicate via a personal area network (e.g., BLUETOOTH), near-field communication (NFC), and/or any additional type of radiofrequency communication. However, additional or alternate communication methods, such as a dedicated short-range communications (DSRC) channel and/or mobile telecommunications protocols based on the 3rd Generation Partnership Project (3GPP) standards, are also considered within the scope of the present disclosure. DSRC channels refer to one-way or two-way short-range to medium-range wireless communication channels specifically designed for automotive use and a corresponding set of protocols and standards. The 3GPP refers to a partnership between several standards organizations which develop protocols and standards for mobile telecommunications. 3GPP standards are structured as “releases”. Thus, communication methods based on 3GPP release 14, 15, 16 and/or future 3GPP releases are considered within the scope of the present disclosure.

Accordingly, the vehicle communication system 26 may include one or more antennas and/or communication transceivers for receiving and/or transmitting signals, such as cooperative sensing messages (CSMs). The vehicle communication system 26 is configured to wirelessly communicate information between the vehicle 12 and another vehicle. Further, the vehicle communication system 26 is configured to wirelessly communicate information between the vehicle 12 and infrastructure or other vehicles. It should be understood that the vehicle communication system 26 may be integrated with the controller 14 (e.g., on a same circuit board with the controller 14 or otherwise a part of the controller 14) without departing from the scope of the present disclosure.

The automated driving system 18 is used to provide assistance to the occupant to increase occupant awareness and/or control behavior of the vehicle 12. In the scope of the present disclosure, the automated driving system 18 encompasses systems which provide any level of assistance to the occupant (e.g., blind spot warning, lane departure warning, and/or the like) and systems which are capable of autonomously driving the vehicle 12 under some or all conditions (e.g., automated lane keeping, adaptive cruise control, fully autonomous driving, and/or the like). It should be understood that all levels of driving automation defined by, for example, SAE J3016 (i.e., SAE LEVEL 0, SAE LEVEL 1, SAE LEVEL 2, SAE LEVEL 3, SAE LEVEL 4, and SAE LEVEL 5) are within the scope of the present disclosure.

In an exemplary embodiment, the automated driving system 18 is configured to detect and/or receive information about the environment 28 surrounding the vehicle 12 and process the information to provide assistance to the occupant. In some embodiments, the automated driving system 18 is a software module executed on the controller 14. In other embodiments, the automated driving system 18 includes a separate automated driving system controller, similar to the controller 14, capable of processing the information about the environment 28 surrounding the vehicle 12. In an exemplary embodiment, the automated driving system 18 may operate in a manual operation mode, a partially automated operation mode, and a fully automated operation mode.

In the scope of the present disclosure, the manual operation mode means that the automated driving system 18 provides warnings or notifications to the occupant but does not intervene or control the vehicle 12 directly. In a non-limiting example, the automated driving system 18 receives information from the one or more vehicle sensors 16. Using techniques such as, for example, computer vision, the automated driving system 18 understands the environment 28 surrounding the vehicle 12 and provides assistance to the occupant. For example, if the automated driving system 18 identifies, based on data from the one or more vehicle sensors 16, that the vehicle 12 is likely to collide with a remote vehicle, the automated driving system 18 may use a display to provide a warning to the occupant.

In the scope of the present disclosure, the partially automated operation mode means that the automated driving system 18 provides warnings or notifications to the occupant and may intervene or control the vehicle 12 directly in certain situations. In a non-limiting example, the automated driving system 18 is additionally in electrical communication with components of the vehicle 12 such as a brake system, a propulsion system, and/or a steering system of the vehicle 12, such that the automated driving system 18 may control the behavior of the vehicle 12. In a non-limiting example, the automated driving system 18 may control the behavior of the vehicle 12 by applying brakes of the vehicle 12 to avoid an imminent collision. In another non-limiting example, the automated driving system 18 may control the steering system of the vehicle 12 to provide an automated lane keeping feature. In another non-limiting example, the automated driving system 18 may control the brake system, propulsion system, and steering system of the vehicle 12 to temporarily drive the vehicle 12 towards a predetermined destination. However, intervention by the occupant may be required at any time. In an exemplary embodiment, the automated driving system 18 may include additional components such as, for example, an eye tracking device configured to monitor an attention level of the occupant and ensure that the occupant is prepared to take over control of the vehicle 12.

In the scope of the present disclosure, the fully automated operation mode means that the automated driving system 18 uses data from the one or more vehicle sensors 16 to understand the environment 28 and control the vehicle 12 to drive the vehicle 12 to a predetermined destination without a need for control or intervention by the occupant.

The automated driving system 18 operates using a path planning algorithm which is configured to generate a safe and efficient trajectory for the vehicle 12 to navigate in the environment surrounding the vehicle 12. In an exemplary embodiment, the path planning algorithm is a machine learning algorithm trained to output control signals for the vehicle 12 based on input data collected from the one or more vehicle sensors 16. In another exemplary embodiment, the path planning algorithm is a deterministic algorithm which has been programmed to output control signals for the vehicle 12 based on data collected from the one or more vehicle sensors 16.

In a non-limiting example, the path planning algorithm generates a sequence of waypoints or a continuous path that the vehicle 12 should follow to reach a destination while adhering to rules, regulations, and safety constraints. The sequence of waypoints or continuous path is generated based at least in part on a detailed map and a current state of the vehicle 12 (i.e., position, velocity, and orientation of the vehicle 12). The detailed map includes, for example, information about lane boundaries, road geometry, speed limits, traffic signs, and/or other relevant features. In an exemplary embodiment, the detailed map is stored in the media 22 of the controller 14 and/or on a remote database or server. In another exemplary embodiment, the path planning algorithm performs perception and mapping tasks to interpret data collected from the one or more vehicle sensors 16 and create, update, and/or augment the detailed map.

It should be understood that the automated driving system 18 may include any software and/or hardware module configured to operate in the manual operation mode, the partially automated operation mode, or the fully automated operation mode as described above.

With continued reference to FIG. 1, a remote server system is illustrated and generally indicated by reference number 40. The remote server system 40 includes a server controller 42 in electrical communication with a server database 44 and a server communication system 46. In a non-limiting example, the remote server system 40 is located in a server farm, datacenter, or the like, and connected to the internet.

The server controller 42 includes at least one server processor 48 and a server non-transitory computer readable storage device or server media 50. The description of the type and configuration given above for the controller 14 also applies to the server controller 42. In some examples, the server controller 42 may differ from the controller 14 in that the server controller 42 is capable of a higher processing speed, includes more memory, includes more inputs/outputs, and/or the like. In a non-limiting example, the server processor 48 and server media 50 of the server controller 42 are similar in structure and/or function to the processor 20 and the media 22 of the controller 14, as described above.

The server database 44 is used to store images and bird’s eye view representations environments surrounding vehicles, as will be discussed in greater detail below. In an exemplary embodiment, the server database 44 includes one or more mass storage devices, such as, for example, hard disk drives, magnetic tape drives, magneto-optical disk drives, optical disks, solid-state drives, and/or additional devices operable to store data in a persisting and machine-readable fashion. In some examples, the one or more mass storage devices may be configured to provide redundancy in case of hardware failure and/or data corruption, using, for example, a redundant array of independent disks (RAID). In a non-limiting example, the server controller 42 may execute software such as, for example, a database management system (DBMS), allowing data stored on the one or more mass storage devices to be organized and accessed.

The server communication system 46 is used to communicate with external systems, such as, for example, the controller 14 via the vehicle communication system 26. In a non-limiting example, the server communication system 46 is similar in structure and/or function to the vehicle communication system 26, as described above. In some examples, the server communication system 46 may differ from the vehicle communication system 26 in that the server communication system 46 is capable of higher power signal transmission, more sensitive signal reception, higher bandwidth transmission, additional transmission/reception protocols, and/or the like.

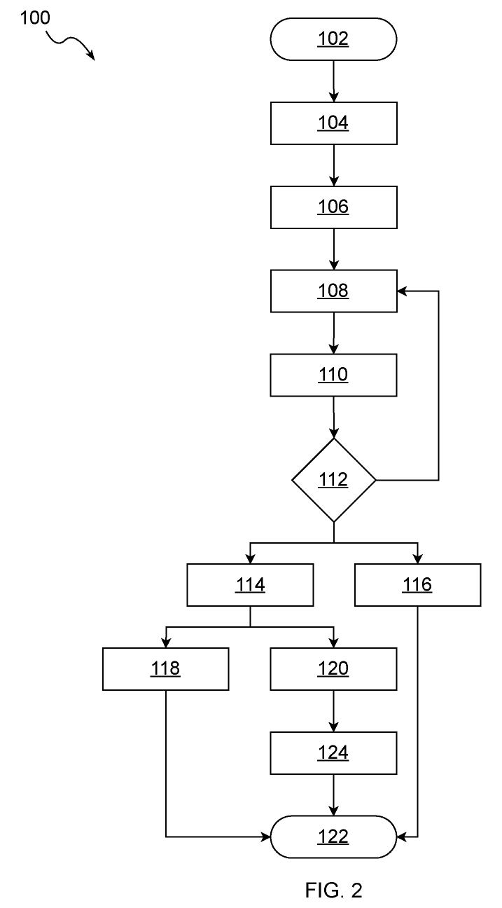

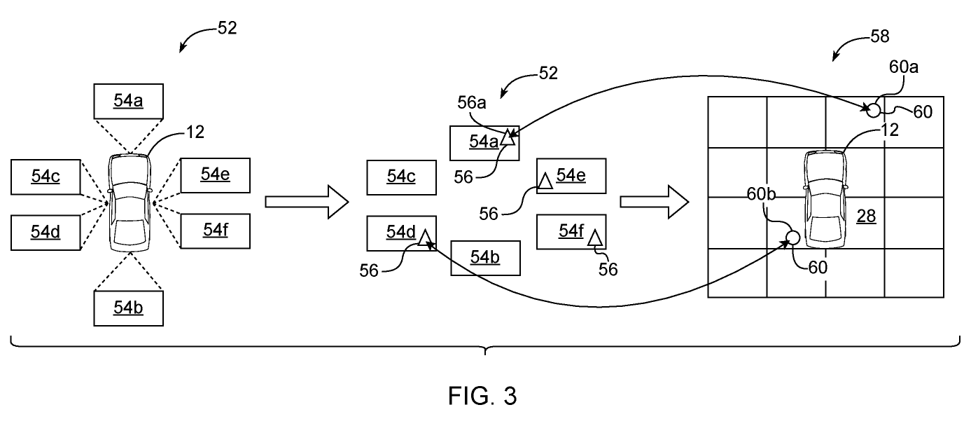

Referring to FIG. 2, a flowchart of the method 100 for adjusting an operation of a vehicle is shown. Referring to FIG. 3, a block diagram for illustration of the method 100 is provided. With reference to FIGS. 2 and 3, the method 100 begins at a starting block 102 and proceeds to block 104. At block 104, the controller 14 uses the camera system 24 to capture a plurality of images 52 of the environment 28 surrounding the vehicle 12. In an exemplary embodiment, the plurality of images 52 includes at least one image showing an environment in front of the vehicle 12, at least one image showing an environment behind the vehicle 12, at least one image showing an environment left of the vehicle 12, and at least one image showing an environment right of the vehicle 12.

In a non-limiting example, the plurality of images 52 includes a first image 54a showing the environment in front of the vehicle 12 and a second image 54b showing the environment behind the vehicle 12. The plurality of images 52 further includes a third image 54c showing an environment in a left-front of the vehicle 12 and a fourth image 54d showing an environment in a left-rear the vehicle 12. The plurality of images 52 further includes a fifth image 54e showing an environment in a right-front of the vehicle 12 and a sixth image 54f showing an environment in a right-rear the vehicle 12. After block 104, the method 100 proceeds to block 106.

At block 106, the controller 14 encodes each of one or more features 56 as an image feature vector. In the scope of the present disclosure, features include objects and/or parts of objects in the environment 28 surrounding the vehicle 12, relations/interactions between objects and/or parts of objects in the environment 28, road markings, road signs, weather conditions, reflections, the sky/horizon, and/or the like. In the scope of the present disclosure, an image feature vector is a multi-dimensional numerical representation of properties or characteristics of a feature determined from an image. For example, properties or characteristics of a feature may include color, size, shape, texture, brightness, reflectivity, distance/location, and/or the like. Image feature vectors are represented in a multi-dimensional feature space.

In an exemplary embodiment, the controller 14 uses an image encoder to generate the one or more image feature vectors. In a non-limiting example, the image encoder is part of a vision-language model that includes aligned image and text encoders. The aligned image and text encoders are trained together to produce aligned embeddings. Therefore, the image encoder generates image feature vectors that are positioned near their corresponding textual feature vectors in the feature space. In the scope of the present disclosure, a textual feature vector is a numerical representation of a string of characters such as one or more words or tokens.

For example, if the one or more features 56 includes a traffic sign, the image feature vector of the traffic sign would be aligned near a textual feature vector encoding the words “traffic sign” in the feature space. Therefore, a textual description (and thus an identification/classification) for any given image feature vector can be determined by querying the feature space for nearby textual feature vectors (e.g., by finding a nearest textual feature vector). Furthermore, information about the one or more features 56 can be retrieved by querying the feature space with a textual feature vector and searching for nearby image feature vectors.

In a non-limiting example, the vision-language model is also referred to as an open-vocabulary vision-language model enabling open-vocabulary, zero-shot classification. Zero-shot classification means that the vision-language model can classify or recognize new features 56 without needing explicit training on those features. Open-vocabulary means that the vision language model can recognize and classify features beyond a fixed set of predefined categories, and is capable of working with arbitrary (e.g., natural language) text inputs and outputs.

In a non-limiting example, the open-vocabulary vision-language model is a Contrastive Language-Image Pretraining (CLIP) image encoder as discussed in, for example, “Learning Transferable Visual Models From Natural Language Supervision” by Radford et al. (International Conference on Machine Learning, Feb. 2021), the entire contents of which is hereby incorporated by reference. In another non-limiting example, the open-vocabulary vision-language model is an open-vocabulary object detection model as described in, for example, “Simple Open-Vocabulary Object Detection with Vision Transformers” by Minderer et al. (ArXiv, Computer Vision and Pattern Recognition, Jul. 2022), the entire contents of which is hereby incorporated by reference. It should be understood that various additional or alternative types of image encoders may be used within the scope of the present disclosure.

Therefore, at block 106, image feature vectors corresponding to each of the one or more features 56 and aligned near corresponding textual feature vectors in the feature space are generated. In a non-limiting example, an image feature vector is generated for each appearance of the feature in any of the plurality of images 52. Therefore, multiple image feature vectors may be generated for the same feature if any of the one or more features 56 appears in multiple of the plurality of images 52 (e.g., due to camera overlap). After block 106, the method 100 proceeds to block 108.

At block 108, the controller 14 selects one of a plurality of two-dimensional locations 60 in the environment 28 surrounding the vehicle 12, for example, a first exemplary location 60a. In the scope of the present disclosure, a two-dimensional location is a location specified in a horizontal plane relative to the vehicle 12 (e.g., by a latitude and a longitude). After block 108, the method 100 proceeds to block 110.

At block 110, the controller 14 generates a bird’s eye view (BEV) image feature vector corresponding to (i.e., including information about) the two-dimensional location selected at block 108 (e.g., the first exemplary location 60a). In the scope of the present disclosure, a BEV image feature vector is similar to the image feature vectors discussed above, but instead of representing a feature in the plurality of images 52, a BEV image feature vector represents a feature in a physical location of the environment 28 relative to the vehicle 12. BEV image feature vectors are represented in a two-dimensional bird’s eye view (BEV) representation 58 of the environment 28. In the scope of the present disclosure, the BEV representation 58 can be understood as a “top-down”, two-dimensional representation of the environment 28 surrounding the vehicle 12, centered on the vehicle 12. Therefore, locations in the BEV representation 58 corresponds to physical locations in the environment 28. In an exemplary embodiment, the controller 14 first establishes a correspondence between locations of the one or more features 56 in the plurality of images 52 and locations in the environment 28 based on known characteristics of the camera system 24 (e.g., camera pose, field-of-view, lens properties, etc.). The controller 14 then identifies one or more image feature vectors corresponding to the two-dimensional location selected at block 108.

In some examples, one image feature vector corresponds to the two-dimensional location selected at block 108. For example, a first exemplary image feature vector 56a corresponds to the first exemplary location 60a in FIG. 3. In a non-limiting example, the BEV image feature vector corresponding to the two-dimensional location selected at block 108 is equal to the one image feature vector corresponding to the two-dimensional location selected at block 108. In another non-limiting example, the BEV image feature vector corresponding to the two-dimensional location selected at block 108 is equal to an image feature vector that is found nearby or in close proximity to the two-dimensional location selected at block 108. For example, neural networks may be used to predict small translations and gather a signal from the corresponding two-dimensional location with respect to these translations.

In another example, multiple image feature vectors correspond to the two-dimensional location selected at block 108 due to, for example, camera overlap as discussed above and/or due to image feature vectors corresponding to multiple vertical heights within the two-dimensional location. In a non-limiting example, the BEV image feature vector corresponding to the two-dimensional location selected at block 108 is equal to an average of all image feature vectors at the two-dimensional location selected at block 108.

For example, the BEV image feature vector corresponding to the two-dimensional location selected at block 108 is equal to an average of one or more image feature vectors corresponding to two or more heights at the two-dimensional location selected at block 108. In another non-limiting example, if many image feature vectors are present at various vertical heights at the two-dimensional location selected at block 108, image feature vectors at predetermined discrete heights (e.g., three image feature vectors spaced one meter apart vertically) are averaged to generate the BEV image feature vector corresponding to the two-dimensional location selected at block 108.

In yet another example, no image feature vectors correspond to the two-dimensional location selected at block 108. In this case, the BEV image feature vector corresponding to the two-dimensional location selected at block 108 is equal to zero, null, a predefined vector, or a learnable vector. After block 110, the method 100 proceeds to block 112.

At block 112, if less than all of the plurality of two-dimensional locations 60 have been selected at block 108, the method 100 returns to block 108 and selects another of the plurality of two-dimensional locations 60 (e.g., a second exemplary location 60b). In an exemplary embodiment, the quantity of the plurality of two-dimensional locations 60 is determined by a predetermined location point density and a predetermined BEV representation size. If all of the plurality of two-dimensional locations 60 have been selected at block 108, the method 100 proceeds to blocks 114 and 116. Therefore, when the method 100 proceeds to blocks 114 and 116, the BEV representation 58 includes a plurality of BEV image feature vectors where each of the plurality of BEV image feature vectors corresponds to one of the plurality of two-dimensional locations 60 in the environment 28. It should also be understood that the calculation of the plurality of BEV image feature vectors may also be performed in parallel (i.e., simultaneously or near-simultaneously for all of the plurality of two-dimensional locations 60) without departing from the scope of the present disclosure.

At block 114, the controller 14 searches the BEV representation 58 with a textual query. In a non-limiting example, the textual query represents a particular object, type of object, part of an object, property of object, relation between objects, or category of object which is desired for further analysis, training, mapping, and/or the like. For example, the textual query may include a road element such as a particular type of lane line/marking. In an exemplary embodiment, to search the BEV representation 58 with a textual query, the controller 14 encodes the textual query as a textual query feature vector in the feature space. The controller 14 then determines whether any BEV image feature vectors in the BEV representation 58 are near (i.e., within a predetermined distance of) the textual query feature vector. After block 114, the method 100 proceeds to blocks 118 and 120.

At block 118, if any BEV image feature vectors are near the textual query feature vector generated at block 114, the textual query is considered to be identified in the BEV representation 58, and the controller 14 saves the plurality of images 52 in the media 22 of the controller 14. In an exemplary embodiment, the plurality of images 52 may be later retrieved for further analysis, training, mapping, and/or the like. In another exemplary embodiment, the plurality of images 52 are transmitted (i.e., using the vehicle communication system 26) to the remote server system 40 for storage and/or use in further analysis, training mapping, and/or the like. After block 118, the method 100 proceeds to enter a standby state at block 122.

At block 120, the controller 14 identifies one or more objects in the environment 28 based on the textual query. In an exemplary embodiment, the controller 14 uses the BEV representation 58 to determine a physical location of any features corresponding to BEV image feature vectors which are near the textual query feature vector in the feature space. Therefore, because of the open-vocabulary and zero-shot capabilities of the image encoder, objects in the environment 28 may be identified and/or located using textual queries (e.g., natural language textual queries), even if the image encoder was not explicitly trained on the particular type of object being queried. After block 120, the method 100 proceeds to block 124.

At block 124, the controller 14 adjusts an automated routing of the vehicle 12 based at least in part on the one or more objects identified at block 120. In an exemplary embodiment, the controller 14 uses the automated driving system 18 to calculate an automated route for the vehicle 12 based at least in part on the one or more objects identified at block 120. In a non-limiting example, the path planning algorithm of the automated driving system 18 takes into account semantic information about the one or more objects to calculate the automated route (e.g., accelerating, braking, stopping, steering to avoid the one or more objects, and/or the like). Furthermore, the controller 14 uses the automated driving system 18 to control acceleration, braking, and/or steering of the vehicle 12 to route the vehicle 12 along the automated route. After block 124, the method 100 proceeds to enter the standby state at block 122.

At block 116, the controller 14 transmits the plurality of images 52 and the corresponding BEV representation 58 to the remote server system 40 using the vehicle communication system 26. In an exemplary embodiment, the server controller 42 of the remote server system 40 is configured to receive the plurality of images 52 and the corresponding BEV representation 58 using the server communication system 46 and store the plurality of images 52 and the corresponding BEV representation 58 in the server database 44. In a non-limiting example, the server controller 42 is further configured to allow for querying and retrieval of images from the server database 44 using textual queries. In an exemplary embodiment, the server database 44 accumulates a multitude of BEV representations and corresponding images from a plurality of vehicles (i.e., crowdsourcing).

The server database 44 may be queried to retrieve images of specific features or objects, types of features or objects, classes of features or objects, and/or the like, for use in training of machine learning algorithms such as, for example, path planning algorithms. In another non-limiting example, the server controller 42 is further configured to perform perception and mapping tasks to interpret the multitude of BEV representations accumulated in the server database 44 to create, update, and/or augment a detailed map of the environment 28. After block 116, the method 100 proceeds to enter the standby state at block 122.

In an exemplary embodiment, the controller 14 repeatedly exits the standby state 122 and restarts the method 100 at block 102. In a non-limiting example, the controller 14 exits the standby state 122 and restarts the method 100 on a timer, for example, every three hundred milliseconds.

The system 10 and method 100 of the present disclosure offer several advantages. Using the open-vocabulary, zero-shot identification/classification techniques of the system 10 and method 100, novel objects which were not present and/or not annotated in training data may be identified and semantically categorized. Accordingly, automated driving systems may appropriately react to the presents of objects and can take into account associated semantic information about the objects (e.g., road markings). Furthermore, the system 10 and method 100 can be used to crowdsource data about objects encountered on/near roadways and provide efficient methods for search and retrieval of specific data using open-vocabulary textual queries. Additionally, the system 10 and method 100 can be used to perform perception and mapping tasks to create, update, and/or augment detailed maps of the environment.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for adjusting an operation of a vehicle, the system comprising:
a camera system configured to capture a plurality of images of an environment surrounding the vehicle; and
a controller in electrical communication with the camera system, wherein the controller is programmed to:
capture the plurality of images of the environment surrounding the vehicle using the camera system;
encode one or more features in one or more of the plurality of images using an image encoder, wherein one of the one or more features is encoded as an image feature vector, wherein the image feature vector is aligned near a corresponding textual feature vector in a feature space, and wherein the corresponding textual feature vector is generated based on a textual description of the one of the one or more features;
generate a two-dimensional bird's eye view (BEV) representation of the environment surrounding the vehicle based at least in part on the one or more features, wherein to generate the BEV, the controller is further programmed to:
identify one or more image feature vectors corresponding to each of a plurality of two-dimensional locations in the environment surrounding the vehicle; and
generate a plurality of BEV image feature vectors, wherein each of the plurality of BEV image feature vectors corresponds to one of the plurality of two-dimensional locations, wherein each of the plurality of BEV image feature vectors is an average of the one or more image feature vectors corresponding to the one of the plurality of two-dimensional locations, and wherein each of the plurality of BEV image feature vectors is an average of the one or more image feature vectors located at two or more heights at the one of the plurality of two-dimensional locations; and
adjust the operation of the vehicle based at least in part on information about the environment surrounding the vehicle encoded in the BEV representation.

2. The system of claim 1, wherein the plurality of images includes at least one image showing an environment in front of the vehicle, at least one image showing an environment behind the vehicle, at least one image showing an environment left of the vehicle, and at least one image showing an environment right of the vehicle.

3. (canceled)

4. (canceled)

5. The system of claim 1, wherein the image encoder is part of an open-vocabulary vision-language model configured for open-vocabulary, zero-shot classification by generating image feature vectors aligned near corresponding textual feature vectors in the feature space.

6. The system of claim 5, wherein the open-vocabulary vision-language model is a Contrastive Language-Image Pretraining (CLIP) image encoder.

7. The system of claim 1, wherein to adjust the operation of the vehicle, the controller is further programmed to:
search the BEV representation with a textual query; and
save the plurality of images in a non-transitory memory in response to identifying the textual query in the BEV representation.

8. The system of claim 1, wherein to adjust the operation of the vehicle, the controller is further programmed to:
search the BEV representation with a textual query;
identify one or more objects in the environment surrounding the vehicle based at least in part on the textual query using the BEV representation; and
adjust an automated routing of the vehicle based at least in part on the one or more objects in the environment.

9. The system of claim 8, further comprising an automated driving system in electrical communication with the controller, wherein to adjust the automated routing of the vehicle, the controller is further programmed to:
calculate an automated route for the vehicle based at least in part on the one or more objects in the environment using the automated driving system; and
control an acceleration, braking, and/or steering of the vehicle using the automated driving system to route the vehicle along the automated route.

10. The system of claim 1, further comprising a vehicle communication system in electrical communication with the controller, wherein the controller is further programmed to:
transmit the plurality of images and the BEV representation to a remote server system using the vehicle communication system, wherein the remote server system is configured to store the plurality of images and the BEV representation and allow for querying and retrieval of images using textual queries.

11. A method for adjusting an operation of a vehicle, the method comprising:
capturing a plurality of images of an environment surrounding the vehicle using a camera system, wherein capturing the plurality of images further comprises:
capturing at least one image showing an environment in front of the vehicle, at least one image showing an environment behind the vehicle, at least one image showing an environment left of the vehicle, and at least one image showing an environment right of the vehicle;
encoding one or more features in one or more of the plurality of images using an image encoder, wherein encoding the one or more features further includes generating one or more image feature vectors using the image encoder, wherein each of the one or more image feature vectors corresponds to one of the one or more features, wherein each of the one or more image feature vectors is aligned near a corresponding textual feature vector in a feature space, and wherein encoding the one or more features further comprises:
generating the one or more image feature vectors using the image encoder, wherein the image encoder is part of an open-vocabulary vision-language model;
generating a two-dimensional bird's eye view (BEV) representation of the environment surrounding the vehicle based at least in part on the one or more features, wherein generating the BEV further comprises:
identifying one or more image feature vectors corresponding to each of a plurality of two-dimensional locations in the environment surrounding the vehicle; and
generating a plurality of BEV image feature vectors, wherein each of the plurality of BEV image feature vectors corresponds to one of the plurality of two-dimensional locations, wherein each of the plurality of BEV image feature vectors is an average of the one or more image feature vectors corresponding to the one of the plurality of two-dimensional locations, and wherein each of the plurality of BEV image feature vectors is an average of the one or more image feature vectors corresponding to two or more heights at the one of the plurality of two-dimensional locations; and
adjusting the operation of the vehicle based at least in part on information about the environment surrounding the vehicle encoded in the BEV representation.

12. (canceled)

13. (canceled)

14. (canceled)

15. (canceled)

16. The method of claim 11, wherein adjusting the operation of the vehicle further comprises:
searching the BEV representation with a textual query;
identifying one or more objects in the environment surrounding the vehicle based at least in part on the textual query using the BEV representation; and
adjusting an automated routing of the vehicle based at least in part on the one or more objects in the environment.

17. The method of claim 16, wherein adjusting the automated routing of the vehicle further comprises:
calculating an automated route for the vehicle based at least in part on the one or more objects in the environment using an automated driving system; and
controlling an acceleration, braking, and/or steering of the vehicle using the automated driving system to route the vehicle along the automated route.

18. A system for adjusting an operation of a vehicle, the system comprising:
a camera system configured to capture a plurality of images of an environment surrounding the vehicle; and
a controller in electrical communication with the camera system, wherein the controller is programmed to:
capture the plurality of images of the environment surrounding the vehicle using the camera system, wherein the plurality of images includes at least one image showing an environment in front of the vehicle, at least one image showing an environment behind the vehicle, at least one image showing an environment left of the vehicle, and at least one image showing an environment right of the vehicle;
encode one or more features in one or more of the plurality of images using an image encoder, wherein one of the one or more features is encoded as an image feature vector, wherein the image feature vector is aligned near a corresponding textual feature vector in a feature space, and wherein the corresponding textual feature vector is generated based on a textual description of the one of the one or more features;
generate a two-dimensional bird's eye view (BEV) representation of the environment surrounding the vehicle based at least in part on the one or more features, wherein to generate the BEV, the controller is further programmed to:
identify one or more image feature vectors corresponding to each of a plurality of two-dimensional locations in the environment surrounding the vehicle; and
generate a plurality of BEV image feature vectors, wherein each of the plurality of BEV image feature vectors corresponds to one of the plurality of two-dimensional locations, wherein each of the plurality of BEV image feature vectors is an average of the one or more image feature vectors corresponding to the one of the plurality of two-dimensional locations, and wherein each of the plurality of BEV image feature vectors is an average of the one or more image feature vectors located at two or more heights at the one of the plurality of two-dimensional locations; and
adjust an automated routing of the vehicle based at least in part on information about the environment surrounding the vehicle encoded in the BEV representation.

19. (canceled)

20. The system of claim 18, further comprising an automated driving system in electrical communication with the controller, wherein to adjust the automated routing of the vehicle, the controller is further programmed to:
search the BEV representation with a textual query;
identify one or more objects in the environment surrounding the vehicle based at least in part on the textual query using the BEV representation;
calculate an automated route for the vehicle based at least in part on the one or more objects in the environment using the automated driving system; and
control an acceleration, braking, and/or steering of the vehicle using the automated driving system to route the vehicle along the automated route.

21. The system of claim 1, wherein to determine the textual description of the one of the one or more features, the controller is further programmed to:
identify a textual feature vector nearest to the image feature vector in the feature space; and
determine the textual description based at least in part on the textual feature vector nearest to the image feature vector in the feature space.

22. The system of claim 1, wherein the one or more features include at least one of: relations between objects, interactions between objects, weather conditions, reflections, or a sky or horizon in the environment surrounding the vehicle.

23. The method of claim 11, wherein generating the one or more image feature vectors further comprises:
generating, for a same feature, multiple image feature vectors corresponding to respective appearances of the same feature across multiple of the plurality of images.

24. The method of claim 11, wherein encoding the one or more features further comprises:
generating the one or more image feature vectors using the image encoder, wherein the open-vocabulary vision-language model is configured for open-vocabulary, zero-shot classification.

25. The method of claim 16, wherein searching the BEV representation further comprises:
encoding the textual query as a textual query feature vector; and
identifying one or more BEV image feature vectors within a predetermined distance of the textual query feature vector in the feature space.

26. The method of claim 17, wherein calculating the automated route further comprises:
calculating the automated route based at least in part on semantic information about the one or more objects in the environment.

27. The system of claim 18, wherein the controller is further programmed to:
transmit the plurality of images and the BEV representation to a remote server system, and wherein the remote server system is configured to perform perception and mapping tasks using the BEV representation to create, update, or augment a map of the environment.
